(19) United States
(12) Patent Application Publication
(10) Pub. No.: US 2019/0295040 A1
(43) Pub. Date: Sep. 26, 2019

(54) ENC System

(71) Applicant: Darryl Clines, St. Louis, MO (US)

(72) Inventor: Darryl Clines, St. Louis, MO (US)

(21) Appl. No.: 15/233,596

(22) Filed: Aug. 10, 2016

(51) Int. Cl. G06Q 10/10; G06F 16/9535

(52) U.S. Cl. CPC G06Q 10/1053; G06F 16/9535

(57) ABSTRACT

The ENC System is an easy-to-use online employment networking system application, designed to network Employers with a modifiable filtered list of specific prospective employee matches, while allowing Employment Tracking Organizations to track all of the system's activity. The ENC System, as a whole, is comprised of individually personalized resume portals, created by Job Seekers, allowing them to upload their online resumes, photos, current locations, social media field proxies, education and work histories, acquired skill sets, videos, etc; Employers seeking to employ a defined skill set, filtered through ranked profiles in specific location areas, housed in the system's preregistered access portal; while an Employment Tracking Organization is granted the ability to track all of the activity stored within the database. Lastly, the system will host a crowd-sourced review channel, designed to cross reference the job seeker's work history, within the community of employers, allowing them to provide insight on the past or present employee's experience with their past employer, generating them an employer community profile rank. The system will be designed to interact with all communication platforms (mobile, tablets, PCs, laptops etc). Other methods and apparatuses are also described.

### BACKGROUND OF THE INVENTION

### Field of the Invention

The process of searching for employment opportunities particularly isn't the most enjoyable experience, despite its necessity for those that are either unemployed or transitioning. Today, with the expansion of our web community, there are a number of different resources available to assist with job searching, improving on the process of pursuit, substantially, with each new innovation.

Although we have many more options available to us, job sites still have a place in this process. There are many different job sites online and using the search facility can help you find the one which suits your experience and skills. If you search for the job title and location on Google, you will obtain a list of job sites which are relevant to you. Job sites also provide an option for registering, so you can receive an email when any relevant opportunities come up. This saves you the time searching for opportunities on a daily basis.

Recruitment agencies can be an effective source for job hunting and many have the option for registering online, rather than physically going to the office. The more agencies you register with, the greater your options, so it is well worth taking the time to broaden your options.

Social media can offer a wide range of options when it comes to searching for jobs online. There is a job searching facility on LinkedIn for instance, but you can also let your connections know that you are currently seeking work. Social media platforms such as Facebook and Twitter also allow you to search for keywords, so you can find relevant jobs which suit your skills and experience.

When it comes to searching for a job online, you need to be pro-active with your search. You can use platforms such as LinkedIn to find useful connections, such as recruiters or business owners and ask them if they have any opportunities. Advertising jobs via job sites can be costly, so many employers choose to headhunt instead.

Many businesses will only advertise on their own website, due to the cost of advertising elsewhere. It is a good idea to make a list of potential employers in a field and search via their website to find out if they have any relevant opportunities.

Most employment websites provide employers with an option for free advertising, so this can be a useful resource to try when searching for a job seekers online. You can also register on the website so that you receive alerts when any relevant opportunities arise, currently.

### BRIEF SUMMARY OF THE INVENTION

The present invention relates to social media community building and its growing necessity for external recruitment and that community's continuing participation as the cornerstone of the system's overall integrity and viability. The ENC System is designed to register job seekers and employers, in an attempt to facilitate an employment filtering community allowing job seekers to register in the front office of the system and market themselves to potential employers, while employers are allowed to register in the back office of the system, granting the access to filtered prospective employee submitted data and exclusive access to a rating system defined by other fellow employers of every registered employee/job seeker employed by them in the past. The user profile proxy can be accessed via the user's assigned communication device mediums (cell phone, laptop, tablet, desktop pc and/or the latest web communication system). The ENC System community will revolutionize the process of n workforce recruitment and the accessibility of top ranked filtered prospects without the cost associated with thorough due diligence. As an added aid to the job seeker, the ENC System will filter real-time announcements of jobs listed within a registered job seeker's preset criteria, without the repetition involved in individualized job search application.

The techniques employed will serve as an employment community for providing enhanced insight into job placement strategy with minimum human interaction, thus alleviating the need to search a variety of databases and being provided with opportunity information based on profile registration. According to the system's embodiment, sequential database queries, progressively prompts the end-user to make entries, systematically categorizing the profile, generating the requested alert responses deployed, tailored to the specific need of the end-user.

### BRIEF DESCRIPTION OF APPLIED TECHNOLOGY COMPONENTS

A proxy or a proxy server acts as another computer which serves as a hub through which internet requests are processed. By connecting through one of these servers, a computer sends a request to the proxy server which then processes the request and returns what was/is requested. Proxies are used for a number of reasons, such as to filter web content, to go around restrictions such as parental blocks, to screen downloads and upload, and to provide anonymity when surfing the internet. Proxies are also used like search engines, except that you enter a website address instead of a search query into a form, returning web pages rather than search results, without being required to install additional software or system modifications to the computer networking settings.

Document Conversion software acts in converting one or more document format to another, which allows the document to be read in many more applications. Documents can be converted into: 1) other source document formats; 2) consumer formats; 3) structured data.

A Search Engine is a program that searches for and identifies items in a database that correspond to keywords or characters specified by the user, used especially for finding particular sites on the World Wide Web.

Autofill is a function in some computer applications or programs, typically those containing forms, which fills in a field automatically.

Disclaimer: The following images depict the composition of the “ENC System” in multiple and progressive component structure formats. The decision to illustrate the system in an expanded format is not a suggestion that this process can only be accomplished within this setting or limited to this design template. The decision to select this setting for the multi-phased system was solely an attempt to relate the principles of the methodology in a fundamental setting to establish a logical correlation. The position of component structures, the size of components and/or the number of structures visible should not be assumed as definitive and/or absolute in accomplishing the desired tasks. It will also become apparent, however, to one skilled in the art, that the embodiments of the present invention may be practiced without these specific details. In other instances, well-known structures and devices are shown in block diagram form, within the “Drawings” submission, rather than in detail, in order to avoid obscuring the embodiments of the present invention. The following images are for illustrative purposes only and should solely be interpreted as such.

Reference in the specification to “one embodiment” or “an embodiment” means that a particular feature, structure, or characteristic described in connection with the embodiment is included in at least one embodiment of the invention. The appearances of the phase “in one embodiment” in various places in the specification do not necessarily all refer to the same embodiment. According to certain embodiments of the invention, a defined approach is utilized to reach full spectrum customers, who will selectively adopt content delivered by a content and/or service provider. (The content can be Best Practice packages available from a pre-produced repository of the content/service provider, or customized packages formed by select-to-use content.) Standard content provides distinct intended low cost, which is the focus of midsize market customers. During a valid subscription period, a customer can subscribe updated content according to its needs. Meanwhile, the content will be updated and stay relevant. New job seekers/employees/employers will save the hassle of implementing generic content. A continuous and close feedback loop tailors standard release portfolios according to market requirements which are based on the trend of customer content requirements and the content/service provider's expectations. Thus, while a content/service provider is focusing on standardized country, industry, as well as requestor-specific requirements (e.g., make-to-order or on-demand), the content/service provider needs an industrialized service center to consistently provide intended low-cost pre-defined content and remote service to customers, partners and the content/service provider internal, including field and development.

### BRIEF DESCRIPTION OF THE SEVERAL VIEWS OF THE DRAWING

### Phase 1

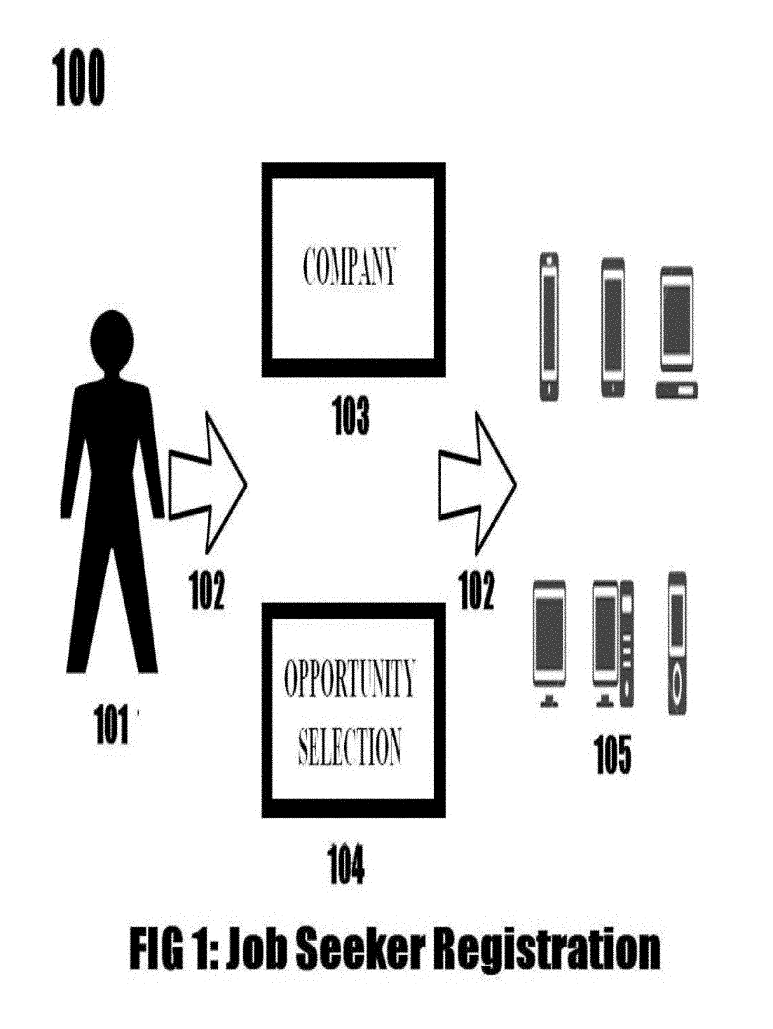

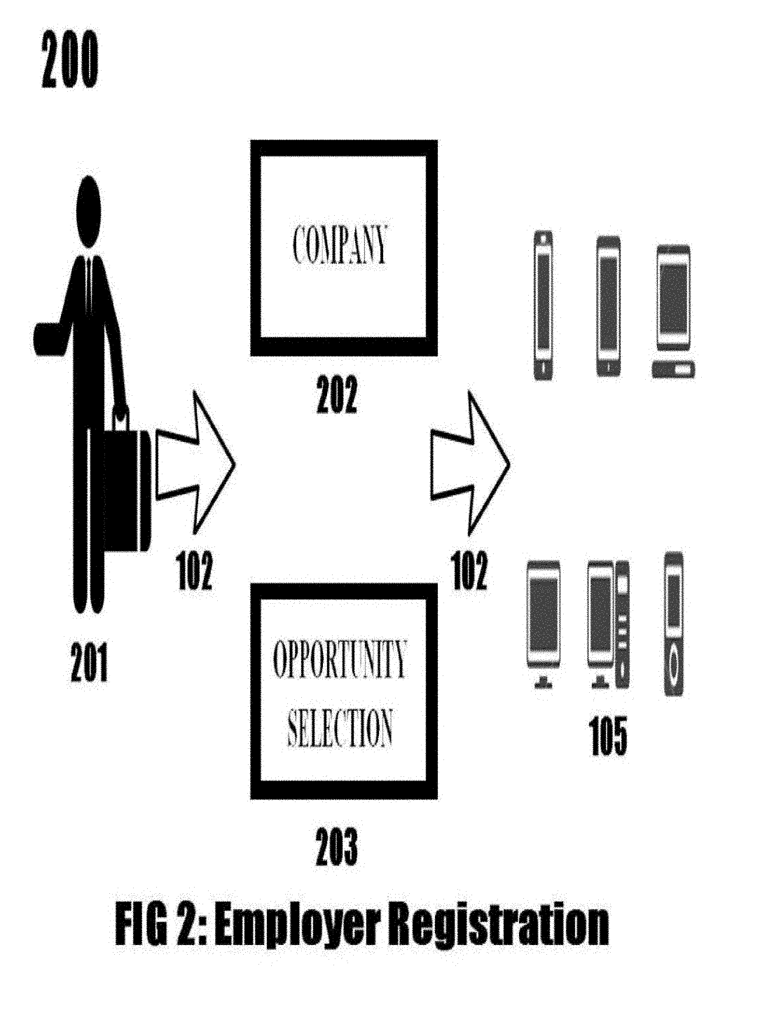

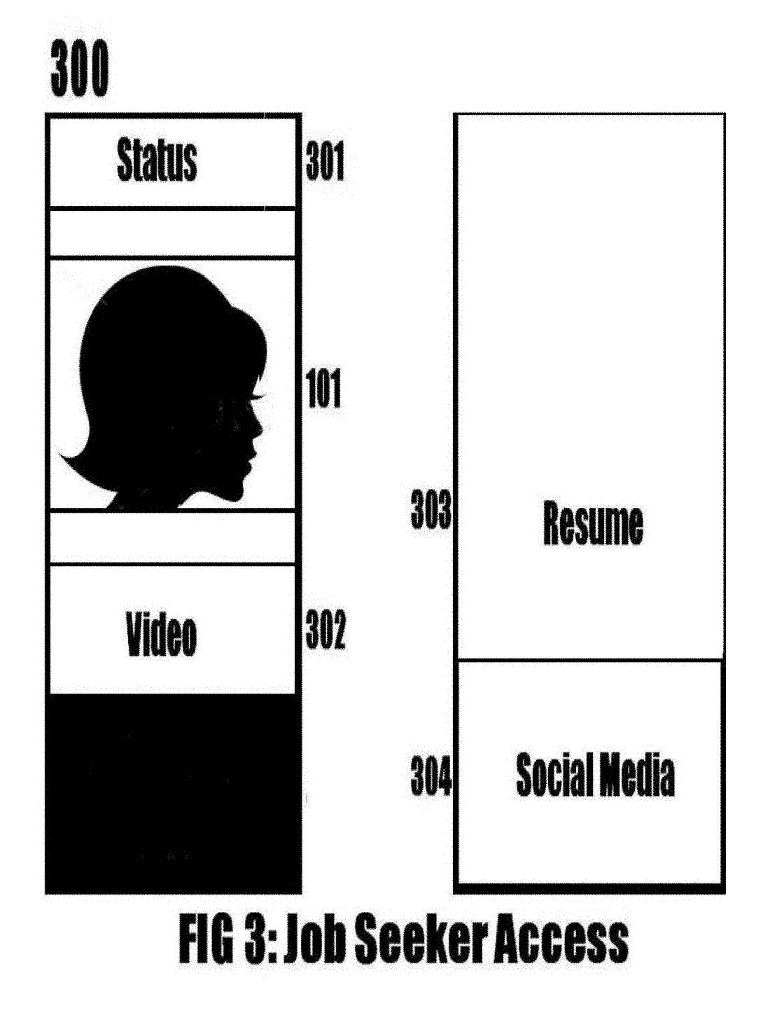

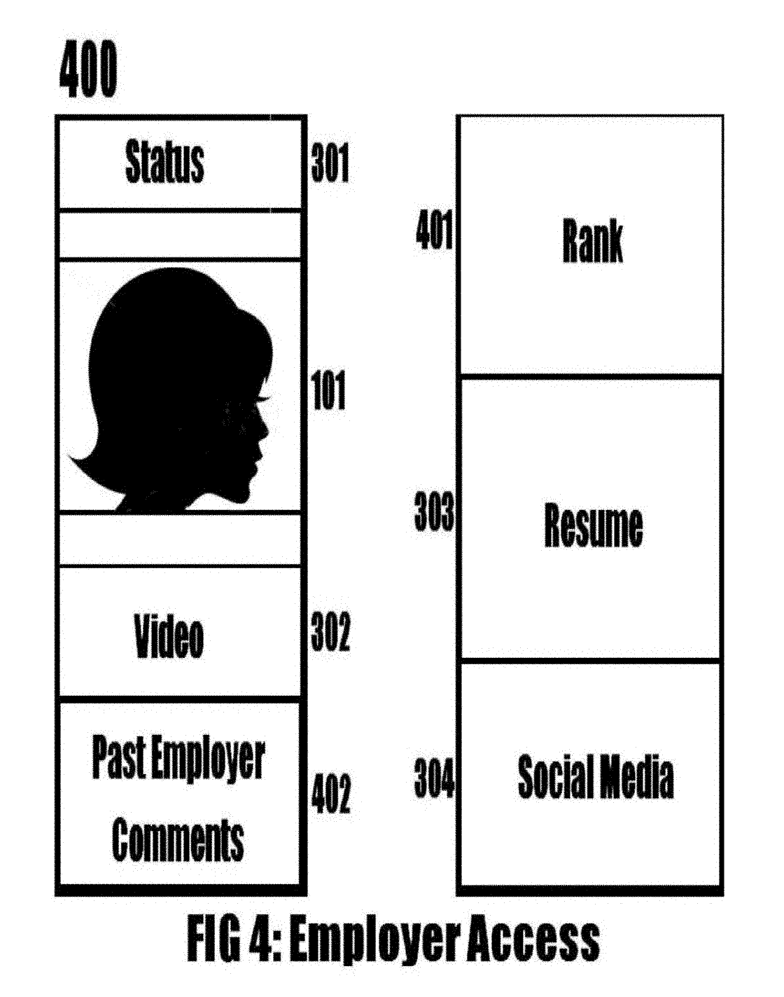

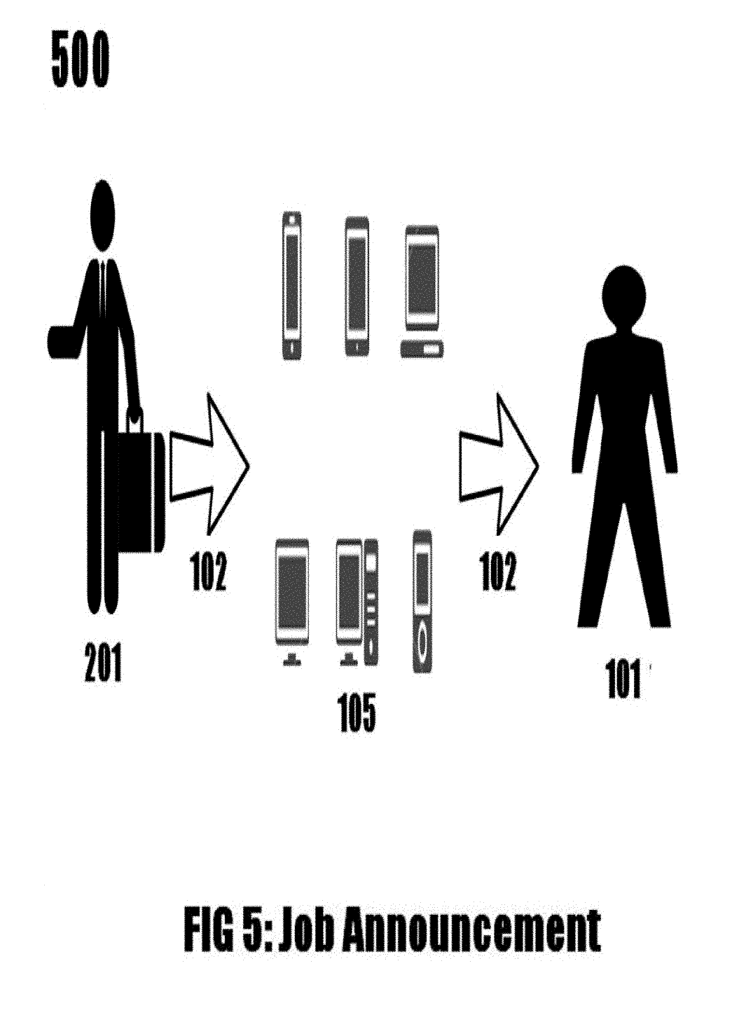

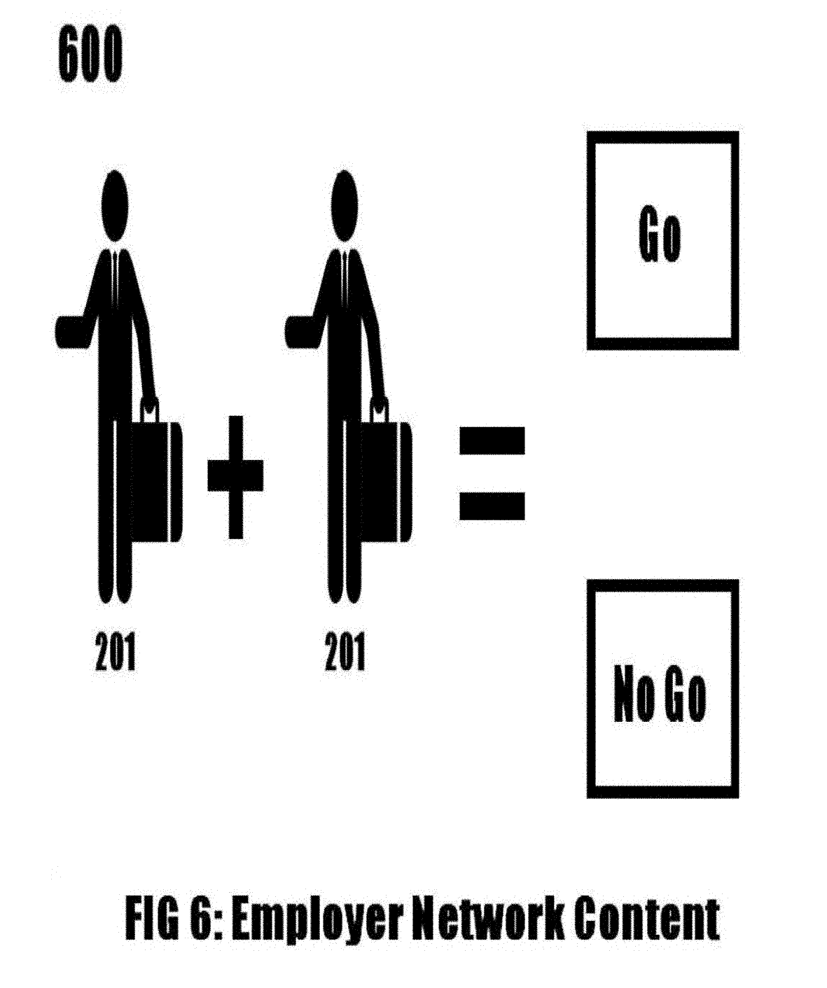

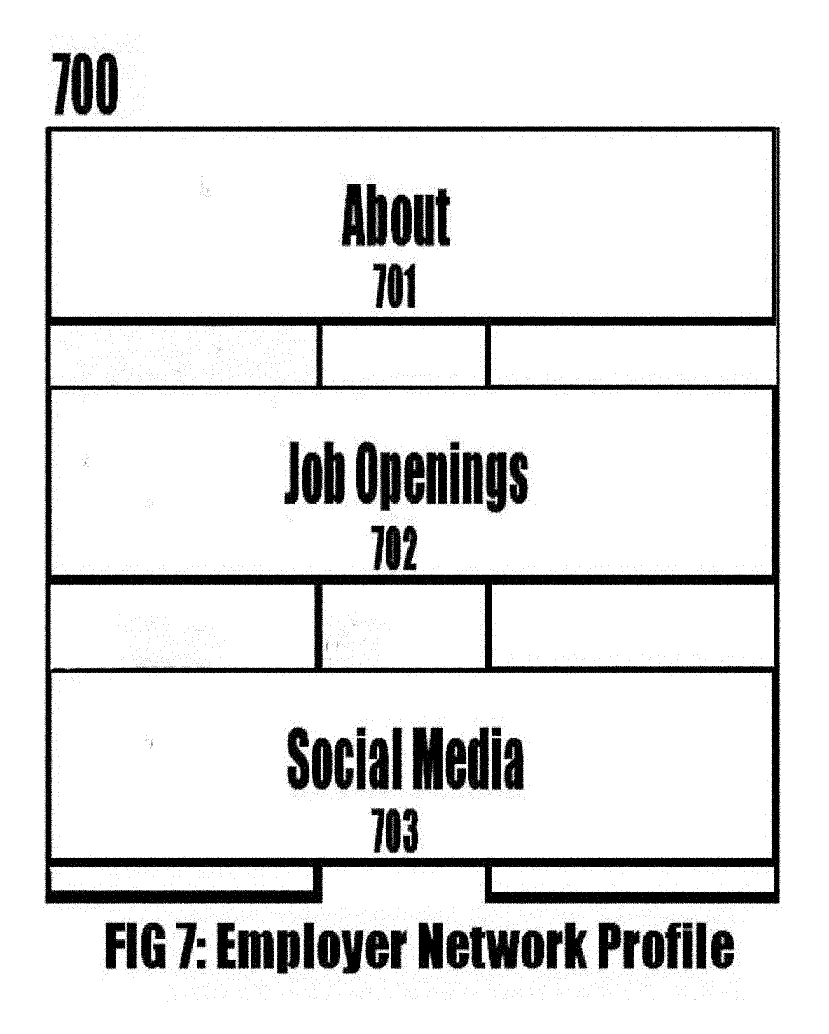

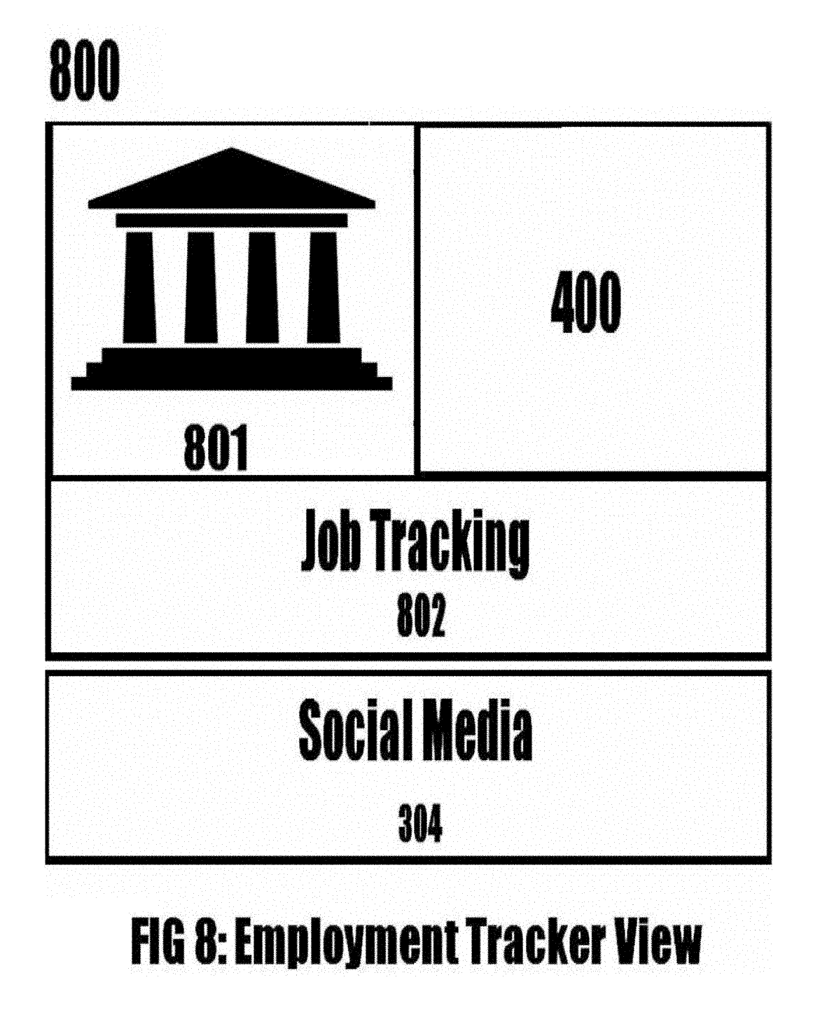

Please refer to the drawings at the end of this example for a key to the reference numbers

| Drawings | Name of Step |
|---|---|
| FIG. 1 | JOB SEEKER REGISTRATION |
| FIG. 2 | EMPLOYER REGISTRATION |
| FIG. 3 | JOB SEEKER ACCESS |
| FIG. 4 | EMPLOYER ACCESS |
| FIG. 5 | JOB ANNOUNCEMENT |
| FIG. 6 | EMPLOYER NETWORK CONTENT |
| FIG. 7 | EMPLOYER NETWORK PROFILE |
| FIG. 8 | EMPLOYMENT TRACKER VIEW |

### Overview:

The ENC System is an easy-to-use web based software program application, which assists in the placement and the recruitment of the unemployed, the underemployed and the transitioning. The ENC System retrieves job announcement opportunities at all participating sector levels, while compiling voluntary profile generated ranking and work history data, on each applicable registered job seeker; contributed by the registered members of the Employer Network community, of which have employed the current job seeker (past/present). The ENC System's embedded real-time functionality is based on the robotic coordination of defined pre-determined matrices that categorically consolidates queried data and communicates the generated listing to the end user's pre-registered communication devices, in real-time. The coordination of the ENC System's Employer Network, is a systemic approach that is principally dependent on the participation of and access to, full spectrum Employers. The ENC System contains a video uploading function, designed to provide the job seeker a tool to further market themselves to the Employer(s).

The goal of the ENC System is to assist companies in making decisions on hiring prospective job seekers with increased visibility via an web based application, while allowing job seekers to stay abreast of all opportunities within their specific field and the ability to further market themselves a step beyond the traditional job application. After a decision has been made, by an Employer, on a promising job seeker, The ENC System will employ a “Video chat/voice call services” function, allowing initial interviews to be conducted via the ENC's embedded system.

FIG. 1 (JOB SEEKER REGISTRATION) (100) illustrates a job seeker (101) registering (102) into the ENC System (100, 200, 300, 400, 500, 600, 700, 800), preparing his/her online work search profile, apply to either a single job announcement (103) or selecting from a listing of available field specific employment opportunities (104), and registering (102) communication mediums (105) to receive future job alert notifications or notification of interest from members of the Employer Network.

FIG. 2 (EMPLOYER REGISTRATION) (200) illustrates an Employer (201) registering (102) into the ENC System's Employer Network, loading the company's profile onto the site (202), listing the opportunities the Employer has available (203) and registering (102) the communication mediums (105) of which the Employer would like use to interact within the Employer Network.

FIG. 3 (JOB SEEKER ACCESS) (300) illustrates the ENC System's completed field of a job seeker's profile (300). The job seeker will be empowered to list his/her Status (301), upload a photo (101), upload a video (302), list his/her resume (303), and receive Employer Network communications, review past application submissions, submit applications and list additional fields of communication.

FIG. 4 (EMPLOYER ACCESS) (400) illustrates the ENC System's Employer vantage point of a job seeker's profile (300), with the added exclusive access to the Employer Network's job seeker ranking system (401) and the Employer Network's Past Employer Comment portal (402).

FIG. 5 (JOB ANNOUNCEMENT) (500) illustrates the ENC System's Employer Network (201) communications (102) with job seeker's (101) about job announcements and other forms of field communications throughout via the company's pre-registered communication medium (105) and the job seeker's device(s) (101; 105).

FIG. 6 (EMPLOYER NETWORK CONTENT) (600) illustrates the ENC System's Employer Network community participation, designed to assist Employers (201) in arriving at making decisions on staffing, based on submitted content contributed by other Employers (201) who have interacted with specific candidates (101) in the past or present.

FIG. 7 (EMPLOYER NETWORK PROFILE) (700) illustrates the ENC System's completed field of an Employer's profile (700). The Employer will be empowered to list information about the company (701), upload job opportunities (702) and a personalized communication portal (703), allowing them to receive Employer Network communications, review past application submissions, receive submitted applications and list additional fields of communication.

FIG. 8 (EMPLOYMENT TRACKER VIEW) (800) illustrates the Employment Tracker portal of which allows an Employment Tracker Organization (801) to job track (802) the pursuit of employment of any registered job seeker (101), view the Employer Network's exclusive content (400, 600) and communicate through a social media multi-channel (304) directly with registered job seekers (101) and registered Employers (201).

### DETAILED DESCRIPTION OF THE INVENTION

The preferred relationship among elements, including preferred logical sequencing, is respectively illustrated in sequential order from FIG. 1 (JOB SEEKER REGISTRATION) and FIG. 2 (EMPLOYER REGISTRATION) to FIG. 7 (EMPLOYER NETWORK PROFILE) with the programmable consideration that the entire ENC System is dependent on the full participation of all elements to allow the system to operate at the fullest extent of its designed potential.

FIG. 1 (JOB SEEKER REGISTRATION) and FIG. 2 (EMPLOYER REGISTRATION) of the ENC System, is the first phase and the registration portal, welcoming Employers (201) and job seekers (101) to register themselves on the ENC System's database; fill-out a series of personalized headings; and register their communication device mediums (105) of which they will conduct communications within the system. The goal of the Registration step of the ENC System is to personalize the end-user's (job seeker/Employer) (101; 201) profile to network the availability of the job seeker (101) with the staffing needs of the Employer (201). After the job seek/Employer (101; 201) registration has been completed, the registered Employer (201) may begin to upload a listing of all of its staffing needs within the ENC community; while the registered job seeker (101) will be asked a series of field specific questions, and granted the opportunity to apply to all desired job opportunities. All of the entries imputed on the site will be stored within the profile of each individual registered field member (101, 201).

After the registration process (FIG. 1 (JOB SEEKER REGISTRATION) and FIG. 2 (EMPLOYER REGISTRATION)) (100; 200) have been completed, FIG. 3 (JOB SEEKER ACCESS) (300) and FIG. 4 (EMPLOYER ACCESS) (400) illustrate the respective views of the job seeker's (101) online job recruitment tool (300; 400) from the vantage point of the public domain (300) and the exclusive vantage point of the Employer Network community (400) as a prospect recruitment tool.

The FIG. 3 (JOB SEEKER ACCESS) (300) portal is a multi-field job recruitment tool inclusive of five (5) entries comprising of;

1. “Status” (301)—employment status; location; availability; current job (if applicable); etc;
2. “Profile Picture” (101)—uploaded image;
3. “Video” (302)—Uploaded video;
4. “Resume” (303)—work history; education; certification(s)/license(s); military service; etc;
5. “Social Media” (304)—video chat/voice call services; email portal; etc.
All information can be updated as required, and the current inputted information will be available to registered employers as requested.

The FIG. 4 (EMPLOYER ACCESS) (400) portal is inclusive of all the five (5) entries of The FIG. 3 (JOB SEEKER ACCESS) (300) portal with exclusive content parts comprising of;

1. “Rank” (401)—composite scoring of a job seeker, decided by the members of the Employer Network community, based on their previous employment of the registered candidate (101);
2. “Past Employer Comments” (402)—comment section about the Employer's (201) experience with the profiled job seeker (101); The “Past employer Comments” section fulfillment is initiated when a job seeker (101) lists an Employer (201) that is also a member of the Employer Network community. The Employer is notified of its listing on the work history (303) of a registered job seeker (101) and then is requested to submit comments on their experience with the job seeker (101) and rank the job seeker's (101) overall performance.

FIG. 5 (JOB ANNOUNCEMENT) (500) illustrates the ENC System's Employer Network (201) communications (102) with job seeker's (101) about job announcements and other forms of field communications throughout via the company's pre-registered communication medium (105) and the job seeker's device(s) (101; 105). The Job Announcement (500) portal welcomes the solicitation of job opportunities submitted by a Employer (201) directly to the field job seekers (101) registered within their field of interest. For example; if a company has a need for sales professionals, the Employer (201) narrow the field of solicitation to exclusively include those that have the desired expertise.

FIG. 6 (EMPLOYER NETWORK CONTENT) (600) illustrates the ENC System's Employer Network community participation, designed to assist Employers (201) in arriving at making decisions on staffing, based on submitted content contributed by other Employers (201) who have interacted with specific candidates (101) in the past or present. The Employer Network Content section (600) outlines the overall goal of all of the contributors of the ENC System (job seekers/Employers); the competitive fulfillment of job openings.

FIG. 7 (EMPLOYER NETWORK PROFILE) (700) illustrates the ENC System's completed field of an Employer's profile (700). The Employer will be empowered to list information about the company (701), upload job opportunities (702) and a personalized communication portal (703), allowing them to receive Employer Network communications, review past application submissions, receive submitted applications and list additional fields of communication. This portal (700) will be viewed by job seekers (101) as a marketing platform of the company and the employment opportunities that the Employer (201) has available.

The FIG. 7 (EMPLOYER NETWORK PROFILE) (700) portal is a multi-field employee recruitment tool inclusive of five (3) entries comprising of;

1. “About” (701)—company profile; location(s); etc;
2. “Job Openings” (702)—uploaded job openings;
3. “Social Media” (703)—video chat/voice call services; email portal; job application field; Employer Network Communication portal; etc.

FIG. 8 (EMPLOYMENT TRACKER VIEW) (800) illustrates the Employment Tracker portal of which allows an Employment Tracker Organization (801) to job track (802) the pursuit of employment of any registered job seeker (101), view the Employer Network's exclusive content (400, 600) and communicate through a social media multi-channel (304) directly with registered job seekers (101) and registered Employers (201).

The FIG. 8 (EMPLOYMENT TRACKER VIEW) (800) portal is a multi-field employment tracking tool inclusive of five (4) entries comprising of;

1. “ETO profile” (801)—Employment Tracking Organization profile; location(s); etc;
2. “Job Seeker Profile” (400) —Registered Job Seeker profile (Employer Network Access);
3. “Job Tracking” (802)—Individual Job Seeker data, tracking the Jobs applied to and the date and time of all system communications.
This portal has exclusive access for registered Employment Tracking Organizations.

The ENC System (100, 200, 300, 400, 500, 600, 700, 800) drawings are pictorial diagrams illustrating an example of a single content service network configuration according to the total embodiment of the invention. The ENC System (100, 200, 300, 400, 500, 600, 700, 800) is a communication center/“marketplace” (100, 200, 300, 400, 500, 600, 700, 800) for content/service providers, and is used to provide services, including content services and remote services, to one or more job seekers/Employers/ETO (101; 201; 800) over a peer driven networking configuration. The network may be part of wide area network (WAN) such as the internet, a local area network (LAN), a metropolitan area network (MAN), or a combination thereof. The ENC System (100, 200, 300, 400, 500, 600, 700, 800) provides an industrialized content service infrastructure that is able to continuously provide high quality and cost effective services remotely to and between job seekers (101) and Employers (201) and real-time, uploaded opportunity selections of pre-selected industrial field′ content (104, 200) electronically delivered to the job seeker's registered electronic web communication devices (105). Content services may be delivered on-demand (also referred to as “made-to-order”), data-retrieval based, and by fee-based subscription. Remote services may be delivered together with other agents that provide onsite support when needed, ongoing. This configuration focuses on standardized country and industry content as well as requestor-specific requirements (e.g., made-to-order). Employer opportunity selection providers (103, 104, 200) may use and complement services provided by the ENC System network community (100, 200, 300, 400, 500, 600, 700, 800).

In one embodiment, the service center/“marketplace” (100, 200, 300, 400, 500, 600, 700, 800) may include a main or central service center (e.g., headquarter) and one or more domestic centers that may be geographically located all over the world. The service center/“marketplace” (100, 200, 300, 400, 500, 600, 700, 800) may provide global services to its job seekers (101) and its registered Employer Network members (201). The service centers located at domestic hubs and other defined locations can provide onsite and local language support for deliverables from and inputs to the central office. For remote services with high portion of oral communication in local languages, when such staffs are not available in the main service center, they will be provided directly from the domestic service centers.

As a result, there are cost efficient options for job seekers (101) and Employment agency opportunity selection providers (103, 104, 200) to offshore standard and tailored content build efforts. In addition, there is a quick turnaround time for requested content through a high degree of production, specialization and global availability. Further; there is a guaranteed quality and up-to-datedness, support through additional services. There is a global reach to job seekers (101) at a desired low cost through the strengthening of remote services for high volume Employers (201). There is also a content back office for the field and support organization. Further, there is an outside-in feedback loop to tailor the Employer Network's (103, 104, 203, 700) content portfolio to market requirements.

The ENC System contains components illustrating an infrastructure of content service models according to the total embodiment of the invention. For example, all systems (100, 200, 300, 400, 500, 600, 700, 800) are incremental parts of a single service center/“marketplace.” The ENC System includes onsite engagement units, which may include certain Employment opportunities (103, 104, 203, 702) and content to provide upfront services to job seekers (101).

In one embodiment, the onsite engagement units (100, 200) may be part of a domestic service center located locally with respect to certain job seekers/Employers (101, 201) to be serviced within the framework of the network configuration. The onsite engagement units (100, 200) are designed to perform certain operations that are assigned to specific registration portals (job seeker (100), Employer (200)), etc. The onsite engagement units (100, 200) may perform additional tasks dependent upon the project's complexity and the registered user's (101, 201) preferences. The Service center/“network” is configured to provide content services to the onsite engagement units (100, 200), including content service selections (104, 103, 203, 702, 703) and other remote services. Content service selections (100, 200) may include on-demand content, catalog-based content, subscription-based content, which includes a variety of types, including analytical reports (300, 400) forms, user interfaces, etc.

On-demand content is referred to, during new content implementations, or when business changes occur during usage, network members (101, 201) may require new forms, reports, configuration or modifications to existing content. Modifications also occur when network members (101, 201) want to customize any standard content obtained from the service network (e.g., part of the ENC System) for their specific needs. An Employer Network member (201) provides content on-demand service through the system network. (the ENC System), to recruit employment opportunity seekers (101) meet these developmental efforts. Job seekers specify required modifications or new content, and the Network (the ENC System) delivers such content together with related knowledge transfer material, to the job seeker's registered communication medium (105).

Catalog-based content is referred to in situations where new and existing network members (101, 201) may require standard content such as downloadable/web accessible forms, reports, etc, to meet generic business needs. They want standard content without taking any subscriptions. To help job seekers (101) get required content, an Employer (201) lists all content items into a content catalog on the service network (the ENC System) and classifies them into different categories for easy browsing. Network members (101, 201) choose the most suitable standard content. This service also caters to Network members (101, 201) with the need for diverse content items and Network members (101, 201) who only require small quantities of access and content each time.

Subscription based content is referred to herein in situations where new and existing Network members (101, 201) of the ENC System may require content such as downloadable forms, reports, etc that may be generic across their industry and/or function. The ENC System offers Network members (101, 201) the option to subscribe to content updates, uploaded in real-time, in a best effort to avoid wasting resources while generic changes occur. Whenever new content becomes discoverable, the ENC System will make them available to all current subscribers (101, 201), based on their registered profile preferences. As their business needs change or evolves, profile/status alteration may be taken to ensure required content used is updated and relevant to maintain personalized real-time content feeds.

The ENC System's service network may be implemented as a web server or a cluster of servers. In one embodiment, the ENC System's service network includes, but is not limited to, user interfaces, which may be implemented as web interfaces, such as, for example, graphical user interfaces (GUIs), a variety of content services such as on-demand content, catalog-based content, subscription-based content, searchable job seeker profiles (300,400) and/or remote services supported by the ENC System content service/support unit.

As shown in FIG. 1 (JOB SEEKER REGISTRATION) (100), the personalized profile Employer opportunity selection retrieval proxy is triggered, generating a list of currently available employment opportunities, based on the user's (101) personalized registration and manual Employer job announcement search. Subscriptions may be compensated for via an embedded e-commerce portal or like service provider for auxiliary services from time-to-time. Subscriptions, for example, may be obtained for a range of time scaling from a “trial” or a “I-time” to a month(s) or a year(s). Subscriptions may determine access to programs from time-to-time.

All network member (101, 201) discoverable profile content can be arranged into a list, based on search engine request functionality, by way of pre-selected opportunity specific selections, availability; and classifies into different categories for easy browsing and searching. Network members (101, 202) have the option to choose the most suitable standard content available along with additional requested content features, with easy content logistics. Opportunities can be search and/or discovered via key-words and the following criteria: (Location; Industry; Language; Content Type; Content Provider; and Business Adaptation Catalog). After the network member's (101, 201) registration has been acknowledged by the automated system (the ENC System), the network member's (10, 201) queried content will be deployed to the network member's (101, 201) registered communication device. According to certain embodiments of the invention, the ENC System continuously provides updates for every sub-category of the registered industry's function, location and employment availability defined in the Employer Network. Updates and new content may be developed in response to business changes, so they will remain relevant to all network members (101, 201) accessing content in their defined area(s). Cross classifications may be implemented.

A Job seeker (101) can search through a defined listing of prospective employment announcements (104) or company profiles (103, 202, 701) discoverable and compiled via an employment search engine field query (103, 104, 203, 702) and receive employment information based on the Employer Network community's field submissions. An Employer (201) can search through a defined listing of prospective employable candidate profiles (400) discoverable and compiled via a job seeker profile (300) search engine query (104, 200) and receive additional background information (401, 402) based on the Employer Network community's field submissions. Once the network member (101, 201) submits content successfully, a notification will be sent to the network member's (101, 201) personalized profile system (105). All members (101, 102) with a specific classification will be notified about updates associated with their specific classification.

Third-party integrators, who may provide additional content that is outside of the designed scope or current capabilities of the ENC System, may be developed by collaborative efforts, between the third-party and the ENC System administrators. Note that some or all of the components of the ENC System may be implemented in software, hardware, app or a combination of both.

FIG. 5 (JOB ANNOUNCEMENT) and FIG. 6 (EMPLOYER NETWORK CONTENT) illustrate web communication processes for networking information associated with the due diligence in conjunction with a registered job seeker's opportunity selection(s) with the ENC community. Note that process 500 (FIG. 5) and 600 (FIG. 6) may be processed by processing logic which may include software, hardware, or a combination of both. For example, process 500 (FIG. 5) may be performed during system 100 (FIG. 1), while process 600 (FIG. 6) is attached as a sub-component of the FIG. 4 (EMPLOYER ACCESS) profile portal.

The ENC System contains an embodiment of which contains a process for providing content services, of which may be processed by processing logic which may include software, hardware, or a combination of both. The ENC System continuously provides updates of content listed in one or more Employer profiles of network content marketplace. A job seeker (101) and or an Employer (201) can browse the network, contained within the content network marketplace to select a category of the content of which they desire and have designed access. In response to an update of content associated by category, a notification is sent to network members with valid access. In response to the notification, the network members (101, 201) may optionally download the updated content and decide whether to access the updated content into their respected profiles.

The ENC System provides an integrated online e-network platform for network members (101, 201) to browse, test, try, download, install, maintain, communicate and purchase content service from the service center for their opportunity selections to implement requirements. On the platform, a network member (101, 201) is able to search, browse and test their yearning or tagging content. Thus, the ENC System “marketplace” is the central online employment opportunity mass retrieval platform which provides intuitive navigation to guide network members (101, 201) to submit their requirements, search, download, install, maintain, email, video chat/voice call services and even review contents (forms, analytics reports, (WEKTRA), etc) and remote service. It provides context-related assistance or contact information when the network member (101, 201) is in the content marketplace. Some searching mechanisms are provided and the network member (101, 201) can easily search content, such as, for example, keyword-based and catalogue-based searching. It provides the network member (101, 201) with a predefined template, tool-based guided questions or forms to fill-in the field requirements, as a wizard in CM to collect network requirements accurately. The content marketplace displays most or all information in local language (e.g., English, Chinese, Italy, Germany, French, Spanish, etc.) and customized automatically in accordance with the network member's system settings.

The content's detailed information (e.g., content attributes and attached documents) can be retrieved from a content repository and can be published to the content marketplace. It provides network members (101, 201) with functions to add content into download basket, delete content from download basket, to integrate with content repository, for example, to push (ITSAM content recommendation for content downloading). The content marketplace has the ability to display content promotion information in the content marketplace and promote the most popular and latest content. The content marketplace may further provide recommendations to a network member (101, 201), including recommendations with information base (iBase), recommendations with pre-selected information, (recommendation with the network member's (101, 201) behavior), recommendations for relevant content, recommendations for upgrade content, display recommendations and recommendations for subscription. When a network member (101, 201) needs additional content in response to a change of business needs, the network member (101, 201) typically searches its local content inventory.

According to certain embodiments of the ENC System, a variety of content is listed in one or more catalogs to be selected to be retrieved and downloaded, either individually or via subscription as described above. The listed content may be located by searching one or more keywords via search field. The catalogs may be arranged via certain categories and/or subcategories. In this example, the ENC System may be implemented based on a business area category. For each of the business area categories, there may be one or more employment opportunity packages listed as subcategories. Likewise, for each employment opportunity package, there may be one or more network topics as another subcategory. A network member (101, 201) may individually select or highlight any of the content or content categories in any of the fields, which may be implemented as a list menu, a popup menu or other various GUIs.

In addition, according to one embodiment, when a network member (101, 201) accesses an item from lists (103, 104, 203, 204, 702), content that satisfies the selection may be displayed in display area settings, which may be sorted according to a variety of rules or polices, such as most popular or most recently posted. Furthermore, the content may be refined according to a variety of categories, such as, for example, by type, by agency, by industry, etc., as well as the number of content items available for each category. The summary of a registered member's (101, 201) proxy account can be accessed via a communication link.

As described above, a network member (101, 201) can search certain content listed in catalogs (103, 104, 203, 204, 300, 400, 700) based on one or more keywords entered in a search field. Each of the content items in the search result includes a summary of the respective content item. The summary of the content item includes, but is not limited to, a brief description, type, version, industry and/or posted date of the content item. The summary of a content item further includes analysis information (100, 200, 300, 400, 700) and reviews or ratings from other Employer Network members (201, 600, 700) for future reference.

Similar to the component structure of a computer system, the data processing system, of which may be used with one embodiment of the ENC System, is not intended to represent any particular architecture or manner of interconnecting the components; as such details are not germane to the present invention. Network computers, handheld computers, cell phones and other data processing systems which have fewer components or perhaps more components, may also be used with the present invention. The system structure of the ENC System, for example, may be an Apple Macintosh compatible computer system or an IBM compatible PC system.

The ENC System, which is in the form of a data processing system, includes a bus or interconnect, coupled to a processor and a ROM, a volatile RAM, and a non-volatile memory. Processor may include multiple processors and/or core logics that constitute central processing units (CPUs) of the system and thus, control the overall operations of the system. According to certain embodiments, the processor accomplishes this by executing software stored in any of the memories, such as, for example, applications and operating systems, etc. The processor may include, one or more programmable general-purpose or special-purpose microprocessors, digital signal processors (DSPs), programmable controllers, application specific integrated circuits (ASICs), programmable logic devices (PLDs), or the like, or a combination of such devices. The processor, which may be, for example, an Intel processor or a PowerPC processor, is coupled to cache memory. The bus interconnects these various components together and also interconnects these components and to a display controller and display device, as well as to input/output (I/O) devices, which may be mice, keyboards, modems, network interfaces, printers, and other devices which are well-known in the art.

Typically, the input/output devices are coupled to the system through input/output controllers. The volatile RAM is typically implemented as dynamic RAM (DRAM) which require power continuously in order to refresh or maintain the data in the memory. The non-volatile memory is typically a magnetic hard drive, a magnetic optic drive, a DVD RAM, a Flash memory, or other type of memory system which maintains data even after power is removed from the system. Typically, the non-volatile memory will also be a random access memory, although this is not required. The present invention may utilize a non-volatile memory which is remote from the system, such as a network storage device which is coupled to the data processing system through a network interface such as a modem or Ethernet interface. The bus may include one or more buses connected to each other through various bridges, controllers, and/or adapters, as is well-known in the art. In one embodiment, the I/O controller includes a. USB (Universal Serial Bus) adapter for controlling USB peripherals. Alternatively, I/O controller may include an IEEE-1394 adapter, also known as FireWire adapter, for controlling FireWire devices. Other components may also be included.

The stability of the ENC System (100, 200, 300, 400, 500, 600, 700, 800) is dependent on the coordination of Employer web portals and their adherence to the systemic compliance standard. After a network member (101, 201) has registered into the ENC System and has answered a series of category placement question, a categorically specific and personalized profile will be created, coordinating resource listings matching the desired opportunity(s). It is also at this point that the network member (101, 201) will register all communication portals that will be registered to receive real-time alert notifications of opportunity announcements. After all prospective opportunities have been selected, the agency (201) and/or job seeker (101) associated with the selection will be listed, along with a profile breakdown and other evaluation material will be available and compiled for the requestor's (101, 201) registered profile domain. Once the network member (101, 201) decides to proceed after evaluating the retrieved information associated with the opportunity, the network member (101, 201) may then have the discovered data stored in preparation to respond or proceed to the decided or invited phase. Once material items have all been requested, compiled information can be retrieved by the network member (101, 201) upon request of the system. In order to accomplish all that is outlined, full access and participation of employment agencies and their web portal will have to be compliant to generate a real-time scenario. Without the synchronized participation of all of the auxiliary employment agencies requested, the stability of the ENC System as a whole will be compromised and unstable.

The goal of the ENC System, as it relates to a job seeker (101) looking for employment with Employers (201) and/or receive notification about other competitive opportunities, is to provide them with real-ti me competitive insight in preparation of pursuing the desired opportunities. For both network members (101, 201) of the ENC System, they will be assisted in having a robotic networking interface compile all of their desired opportunities and notify them, ongoing, of additional opportunities, when they become available.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, that all of these and similar terms are to be associated with the appropriate physical quantities and are merely convenient labels applied to these quantities Unless specifically stated otherwise as apparent from the above discussion, it is appreciated that throughout the description, discussions utilizing terms such as “processing” or “calculating” or “computing” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specifically constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optic disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

The embodiments of the invention in which an exclusive property or privilege is claimed are defined as follows:

1. A computer-implemented method for compiling employment data from subscribers and/or registered users (job seekers, Employers, Employment Tracking Organizations; etc), as a software application proxy system for service (SaaS), designed and comprised of:
three (3) access portals comprised of a Job Seeker's registration portal; a Employer's registration portal; and an Employment Tracking Organization's registration portal, allowing:
A. a discoverable job seeker to personalize a resume portal, with preset entry fields, allowing entries inclusive of a resume/work history entry field; a current status entry field; photo upload field; a video upload field; and a web communication field (including social media communication field, email, document download/upload function and video chat/voice call service network); all included to market his/her abilities to recruit employment opportunities;
B. a discoverable Employer to personalize an employee recruitment port, with preset entry fields;
allowing entries inclusive of a Employer overview section (About); a Job Openings upload field;
a web communication field (including social media communication field, email, document download/upload function and video chat/voice call service network)
a system that can operate as a voluntary and as a subscription-based system; and access to all job seeker profiles with past employer comments and composite ranking of prospective hires; all included to assist Employer with assessing future hires before a final decision is made;
C. an Employment Tracking Organization to track job search activity and Employer feedback of each individual job seeker researched through system query;
a searchable data base system allowing all profiles (job seeker, Employer) to be retrieved as a result of search entry;
populated listing(s) of data and profile data retrieved as a result of embedded search engine request(s);
a preliminary profile registration that personalizes the discovery of requests by requesting a sequential series of classifying criteria entered as data, defining the preference of data retrieved by registered proxy profile, in real-time;
uniquely targeting information directly to the platform of choice in real-time to registered users;
combine employment profile data and/or employment opportunities at all levels, developing a “network” and/or “community,”
dispersing personalized and/or filtered information, in real-time, in accordance with the end-users' (job seekers, Employers, Employment Tracking Organizations) registered communication device(s);
providing Employment Tracking Organization users with historical information on job search activity from any registered platform within the total system;
employing a limited access Employer networking system, sharing firsthand employment background history and establishing a composite score ranking of each registered job seeker, amongst a closed community of Employers and Employment Tracking Organizations;
pairing work history (past/present) entered into the “Resume” portal of the registered Job Seeker, with the registered and listed Employer portal, to initiate a systemic request for the registered Employer listed as a citation within the Job Seeker's “Resume,” in the obtainment of background information on the registered Job Seeker, aiding the Employer Network Community;
generating real-time announcement notifications, based on programmatic preferences and updates, submitted via the software's interface;
assist all registered members (job seekers, employers, employment tracking organizations) with direct communication mediums (email, video chat/voice call services, social media communication channels, document file processor) to allow all accepted formats of communication to be accomplished within the ENC System;
email, messaging, video chat/voice call service and current web based communication medium, etc, located on all profile pages of all ENC System registered members, welcoming for them to communicate amongst each other and conduct interviews for prospective employee (Employers), etc;
in response to a search request for searching a content item, searching within the plurality of categories based on one or more keywords and displaying a search result having one or more content items matching the one or more keywords;
in response to a demand from a user, presenting a request form to allow a user to specify one or more requirements of a specific content item not available from the plurality of categories, wherein the specific content item is to be developed specifically tailored to specific need of the user; and
web communication device(s) registration.

2. The method of claim 1, wherein a preliminary profile registration that personalizes the discovery of requests by requesting a sequential series of classifying criteria entered as data for all registering members (job seekers, employers, employment tracking organizations) comprising:
displaying in a first display area the plurality of categories based on a plurality of selectable employable areas/company registration/organization, field search inquiry and web communication device(s) registration;
for each field search area selected, displaying in a second display area a plurality of tabulated selectable opportunities (employment opportunity, prospect tracking. Employment data tracking) queried by category search enlisted by registration and interface communication among the host, proxy and its field specific web portal;
for each tabulated selectable opportunity, displaying in a third display area are systemic field request for specific field historical information, indicating location, resume, video and social media registration; with a request option to pair the firsthand employment (Employer Network field only) background information with a corresponding listing of the firsthand employer by the registering job seeker;
for each registered member field (job seeker, employer, employment tracking organization) a video upload option will exist, displaying in a fourth display allow all field members (job seeker, employer, employment tracking organization) the option to upload video(s) assisting in the marketing of their personalized profile;
in response to the completion of all or a single area (first, second, third, fourth) of the sequential categories, an alert notification comprised of completed profile information request, can/will be sent to the registered member's web communication device, via software application and/or electronic mail, in real-time.

3. The method of claim 1, Wherein generating real-time announcement notifications comprises:
compiling all of the data requests queried by the registered Job Seeker, via the filtered listing of desired opportunities, posted by registered Employer profiles, into a single discoverable industry field, of which applications may be applied to and/or stored within the Job Seeker's profile, and sent as an alert notification to the Job Seeker's registered communication device (laptop, personal computer, cell phone or latest version of web communication device medium), in real-time; while the total process is replicated and the alert notification is sent to the posting Employer's and the activity tracking Employment Tracking Organization's registered communication device(s) (laptop, personal computer, cell phone or latest version of web communication device medium), in real-time respectively.

4. The method of claim 1, further comprising in response to a selection of a content item from the search result and/or the plurality of categories of application content, displaying one or more attributes including a description about the selected content item.

5. The method of claim 4, further comprising:
displaying a thumbnail image of the selected content item; and
in response to an activation from the thumbnail image, displaying a larger image of the selected content item.

6. The method of claim 4, further comprising displaying comments and/or ratings from other Employer Network users regarding the selected content item, such that the Employer Network user can evaluate the selected content item, in view of the comments and/or ratings from other Employer Network users.

7. The method of claim 4, further comprising, in response to a user (all registered members) input, displaying one or more prerequisites for deploying the selected content item, such that the user (all registered members) can determine whether a system of the user deploying the selected content item satisfies the one or more prerequisites.

8. The method of claim 4, further comprising marking the selected content item as a reference to be used subsequently to create the specific content item specifically tailored to the specific need of the user (all registered members), wherein the specific content item is to be created having characteristics similar to at least a portion of the referenced content item.

9. The method of claim 8, wherein the request form for specifying the one or more requirements of the specific content item includes a first field to link the referenced content item and wherein the request form further includes a second field to select a template to be used as a layout example for the specific content item to be created.

10. The method of claim 8, wherein the request form is displayed in response to an activation of a control from the user (all registered members) while the description of the selected content item is displayed.

11. A machine-readable medium having instructions stored therein, which when executed by a machine, cause the machine to perform a method for providing software as a service (SaaS), the method comprising:
displaying a plurality of categories of application content, each category including a plurality of content items to be browsed and each of the content items selectable to be deployed in a network application;
in response to a search request for searching a content item, searching within the plurality of categories based on one or more keywords and displaying a search result having one or more content items matching the one or more keywords; and
in response to a demand from a user, presenting a request form to allow a user to specify one or more requirements of a specific content item not available from the plurality of categories, wherein the specific content item is to be developed specifically tailored to a specific need of the user (all registered members).

12. The machine-readable medium of claim 11, wherein displaying the plurality of categories of application content comprises:
displaying in a first display area the plurality of categories based on a plurality of selectable employment aspect and/or area;
for each employment aspect and/or area, displaying in a second display area a plurality of selectable employment field opportunity;
for each employment opportunity, displaying in a third and fourth display area a plurality of selectable and corresponding historical data of selected employment opportunity(s); and
in response to a selection(s), displaying one or more content item in a fifth display area, wherein the one or more content items are associated with selected historical data of a selected employment opportunity of a selected employment area.

13. The machine-related medium of claim 11, wherein the method further comprises in response to a selection of a content item from the search result and/or the plurality of categories of application content, displaying one or more attributes including a description about the selected content item.

14. The machine-readable medium of claim 13, wherein the method further comprises:
displaying a thumbnail image of the selected content item, and
in response to an activation from the thumbnail image, displaying a larger image of the selected content item.

15. The machine-readable medium of claim 13, Wherein the method further comprises displaying comments and/or ratings from other users (Employers) regarding the selected content item, such that the user (Employers, Employment Tracking Organizations) can evaluate the selected content item in view of the comments and/or ratings from other users (Employers).

16. The machine-readable medium of claim 13, wherein the method further comprises, in response to a user input, displaying one or more prerequisites for deploying the selected content item, such that the user can determine whether a system of the user deploying the selected content item satisfies the one or more prerequisites.

17. The machine-readable medium of claim 13, wherein the method further comprises marking the selected content item as a reference to be used subsequently to create the specific content item as a reference to be used subsequently to create the specific content item specifically tailored to the specific need of the user, wherein the specific content item is to be created having characteristics similar to at least a portion of the referenced content item.

18. The machine-readable medium of claim 17, Wherein the request form for specifying the one or more requirements of the specific content item includes a first field to link the referenced content item and wherein the request form further includes a second field to select a template to be used as a layout example for the specific content item to be created.

19. The machine-readable medium of claim 17, Wherein the request form is displayed in response to an activation of a control from the user while the description of the selected content item is displayed.

20. A data processing system for providing software as a service (SaaS), comprising:
a processor;
a memory coupled to the processor for storing instructions, which when executed from the memory, cause the processor to
display a plurality of categories of application content, each category including a plurality of content items to be browsed and each of the content items selectable to be deployed in a networking application,
in response to a search request for searching a content item, search within the plurality of categories based on one or more keywords and display a search result having one or more content items matching the one or more keywords, and
in response to a demand from a user, present a request form to allow a user to specify one or more requirements of a specific content item not available from the plurality of categories, wherein the specific content item is to be developed specifically tailored to a, specific need of the user.

21. The system of claim 20, wherein displaying the plurality of categories of application content comprises:
displaying in a first display area the plurality of categories based on a plurality of selectable employment aspect and/or areas;
for each business area, displaying in a second display area a plurality of selectable employment aspect and/or opportunity;
for each employment aspect and/or opportunity, displaying in a third display area a plurality of selectable historical data; and
in response to a selection, displaying one or more content items in a fourth and fifth display area, wherein the one or more content items are associated with selected historical data of a selected employment aspect and/or opportunity(s) of a selected employment aspect and/or area.
